(19) United States
(12) Patent Application Publication
(10) Pub. No.: US 2010/0169402 A1
(43) Pub. Date: Jul. 1, 2010

(54) FAST FOURIER TRANSFORM PROCESSOR

(75) Inventors: Hung-Lin Chen, Kaohsiung County (TW); Yu-Min Lin, Hsinchu City (TW); Dar-Zu Hsu, Tainan County (TW); Yuan Chen, Hsinchu City (TW); Chen-Yi Lee, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/400,794

(22) Filed: Mar. 10, 2009

(30) Foreign Application Priority Data
Dec. 31, 2008 (TW) 97151902

(51) Int. Cl. G06F 17/14

(52) U.S. Cl. 708/404

(57) ABSTRACT

An FFT processor is disclosed, which includes a first multi-pipelined MDC unit, a second multi-pipelined MDC unit and a switching network. The first multi-pipelined MDC unit and the second multi-pipelined MDC unit respectively employ a plurality of MDC circuits to change the positions of the delayers thereof in parallel way. By changing the operation time sequence of the signals in the first multi-pipelined MDC unit and the second multi-pipelined MDC unit, the first multi-pipelined MDC unit is able to directly send the operation results to the second multi-pipelined MDC unit through the switching network.

### CROSS-REFERENCE TO RELATED APPLICATION

This application claims the priority benefit of Taiwan application serial no. 97151902, filed on Dec. 31, 2008. The entirety of the above-mentioned patent application is hereby incorporated by reference herein and made a part of this specification.

### BACKGROUND OF THE INVENTION

1. Field of the Invention

The present invention generally relates to a data processing architecture of Fast Fourier Transform (FFT), and more particularly, to an FFT processor.

2. Description of Related Art

FFT has been broadly used in many fields, which include digital signal processing, image processing and communication system. The FFT technology could be used in designing a hardware circuit architecture of an FFT processor with high processing speed and high throughput. A high speed FFT processor plays a critical role in the fields relating digital signal processing, for example, in an OFDM (orthogonal frequency-division multiplexing) communication system. One major challenge to be overcome for designing an FFT processor includes how to reach a good system transmission efficiency with high throughput and the implementation feasibility by using low cost CMOSs (complementary metal-oxide semiconductors) to build an FFT processor.

U.S. Pat. No. 4,534,009 discloses “Multi-Pipelined FFT Processor”. The pipelined FFT processor is able to perform operation processing on continuously input signals in high efficiency to complete FFT calculations. The processing element used in the circuit architecture is based on a radix-2 butterfly unit (radix-2 BU). FIG. 1 is a diagram of a conventional radix-2 BU 100 able to perform 2-points FFT operations, wherein the butterfly unit 100 can perform 2-points FFT operations. FIG. 2 is a diagram showing an FFT processor architecture according to U.S. Pat. No. 4,534,009, wherein the architecture enables a plurality of radix-2 BUs 100 to connect in series each other to build an processor and the processor is termed as a radix-2 multipath delay commutator (MDC) FFT processor. Taking a 16-points processor as an example, as shown by FIG. 2, a pair of signals are input, and prior entering different processing elements 100 to be operated, the input signals are delivered to different delay units 211, 212 and 214 and a switch 220, so that the time sequence of the signals to be operated are rearranged in a memory so as to ensure no wrong operation result. The delay unit 211 herein has a delay time of a time slot, the delay unit 212 has a delay time of two time slot and the delay unit 214 has a delay time of four time slot. Due to the above-mentioned rearrangement of the time sequence, the usage efficiency of each processing element can reach 100%. By using the scheme, an FFT processor for Y-points operations requires a memory capacity of (1.5Y-2).

In 1984, E. E. Swartzlander, JR, et al published a paper “A Radix 4 Delay Commutator for Fast Fourier Transform Processor Implementation” (IEEE J. Solid-State Circuits, Vol. SC-19, No. 5, October 1984). The processing element of the processor herein is based on a plurality of radix-4 butterfly units (radix-4 BUs), and all the radix-4 BUs and all the BUs are in series connection. The processor herein is accordingly termed as a radix-4 MDC FFT processor. By using the scheme, an FFT processor for Y-points operations requires a memory capacity of (2.5Y-4).

US Patent Application Publication No. 2002/0083107A1 discloses “Fast Fourier Transform Processor Using High Speed Area-Efficient Algorithm”. The processor herein can be seen as a modified architecture of radix-4 processing element, wherein the processor has two different types of processing element: one radix-4 BU and two radix-2 BUs. By interactively connecting in series the two types of processing elements, the above-mentioned processing elements build an FFT processor. Accordingly, the processor is termed as a radix-4/2 MDC FFT processor. Same as the above-mentioned radix-4 MDC FFT processor, an FFT processor for Y-points operations requires a memory capacity of (2.5Y-4).

### SUMMARY OF THE INVENTION

Accordingly, the present invention is directed to an FFT processor. The provided FFT processor includes a first multi-pipelined MDC unit, a second multi-pipelined MDC unit and a switching network. The first multi-pipelined MDC unit performs in parallel way M radix-2^{N} first butterfly operations so as to output a plurality of first operation results, wherein M and N are integers greater than 1. By changing the delayer positions in the first multi-pipelined MDC unit, the time sequence of the outputs is changed. The switching network is coupled to the first multi-pipelined MDC unit for changing the above-mentioned relative positions of the first operation results. The second multi-pipelined MDC unit is coupled to the switching network and uses the first operation results with changed relative positions to perform in parallel way M radix-2^{N} second butterfly operations so as to output a plurality of second operation results.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional radix-2 BU 100 able to perform 2-points FFT operations.

FIG. 2 is a diagram showing an FFT processor architecture according to U.S. Pat. No. 4,534,009.

FIG. 3 is a block diagram of a processing element of an FFT processor according to the embodiment of the present invention.

FIG. 4A is a block diagram of a conventional MDC.

FIGS. 4B-4F are block diagrams showing different novel MDCs according to the embodiment of the present invention.

FIG. 4G is a diagram showing a butterfly operation network for 8-points FFT operations (i.e., radix-8).

FIG. 5 is a block diagram of the first multi-pipelined MDC unit in FIG. 3 according to the embodiment of the present invention.

FIGS. 6A-6D are diagrams showing the internal linking statuses of the switching network in FIG. 3 according to the embodiment of the present invention.

FIG. 7 is a block diagram of the second multi-pipelined MDC unit in FIG. 3 according to the embodiment of the present invention.

FIG. 8 is a block diagram showing an FFT processor according to the embodiment of the present invention.

FIG. 9 is a block diagram showing another FFT processor according to the embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following, the FFT operations are, for example, used for 4096-points to be processed. To accomplish the FFT operations of a given number of operation points, the conventional MDCs, due to the inherent low efficiency thereof, a memory size more than the number of operation points is needed. For example, a conventional radix-2 MDC for processing 4096-points needs a memory size of 6142 words; or a conventional radix-4 MDC for processing 4096-points needs a memory size of 10236 words. However, by using a processing element formed by the following novel MDCs of the embodiments for processing 4096-points, only a memory size of 4096 words is needed, which largely reduces the required memory size, lowers the number of accessing the memory and accordingly effectively reduces the power consumption. In comparison with the conventional MDC circuit, the following embodiments can largely lower the number of accessing the memory, reduce the required memory size and easily implement a processor with a less power consumption, a smaller circuit area and a high throughput. In particular, the throughput of the processor can be easily increased by adding the processing element.

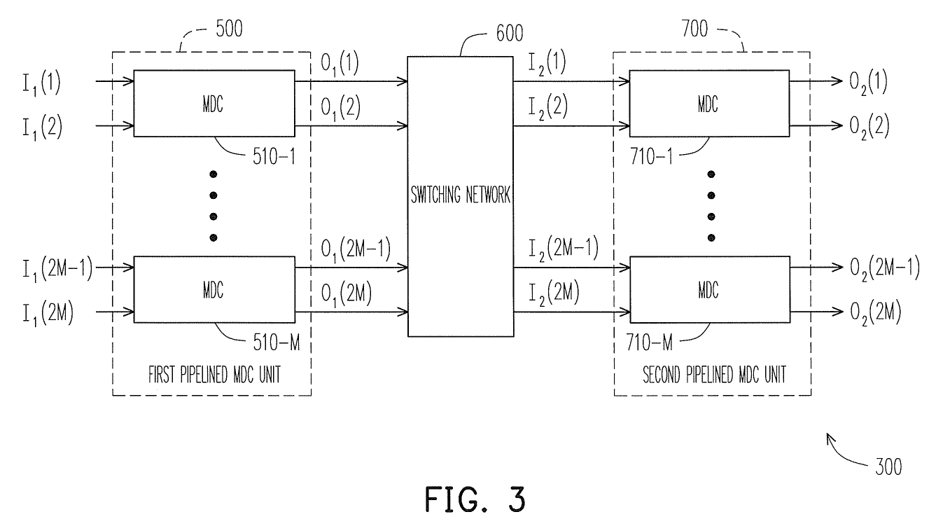

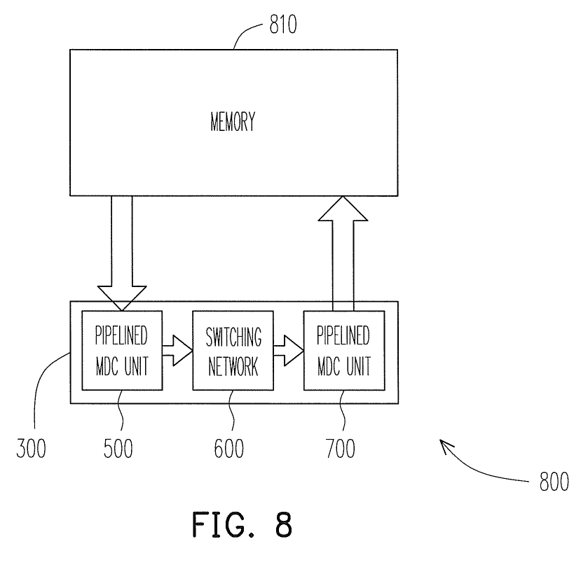

FIG. 8 is a block diagram showing an FFT processor 800 according to the embodiment of the present invention and FIG. 3 is a block diagram of a processing element of an FFT processor 300 in FIG. 8 according to the embodiment of the present invention. In order to accomplish an operation of 4096-points, this embodiment uses a 64-points processor as the processing element 300 (referring to FIGS. 3, 5, 6A-6D and 7). In other words, this embodiment uses two multi-pipelined MDC units 500 and 700 performing in parallel way eight radix-2³ (M=8, N=3) operations to build the processing element 300, wherein the core of each multi-pipelined MDC unit is one of various novel MDCs capable of changing the positions of the delayers thereof, A 64-points processing element 300 is built by the two multi-pipelined MDC units 500 and 700 and a switching network 600, wherein the switching network 600 makes the multi-pipelined MDC units 500 and 700 in series connection. In this way, the processing element 300 in association with a memory of 4096 words 810 can perform an FFT operation for 4096-points. The memory 810 provides the data required by the MDC unit 500 in the processing element 300 to perform in parallel way M radix-2^{N} butterfly operations. In addition, the multi-pipelined MDC unit 700 in each processing element 300 is able to write the operation results into the memory 810, so that during the operation course of the processing element 300, there is no need to accesses the memory 810 for saving/reading the data. The more details about FIGS. 3, 5, 6A-6D and 7 are explained hereinafter.

Referring to FIG. 3, the processing element 300 of the FFT processor includes a first multi-pipelined MDC unit 500, a switching network 600 and a second multi-pipelined MDC unit 700, wherein M and N are integers greater than 1. The first multi-pipelined MDC unit 500 is able to perform in parallel way M radix-2^{N} first butterfly operations so as to output a plurality of first operation results.

The switching network 600 is coupled between the first multi-pipelined MDC unit 500 and the second multi-pipelined MDC unit 700. The switching network 600 can change the relative positions of the first operation results, following by sending the first operation results with changed positions to the second multi-pipelined MDC unit 700. In other words, the switching network 600 is able to change the routing relationship between the first multi-pipelined MDC unit 500 and the second multi-pipelined MDC unit 700. The second multi-pipelined MDC unit 700 uses the first operation results with changed relative positions to perform in parallel way M radix-2^{N} second butterfly operations so as to output a plurality of second operation results. There is no need to use a memory to save/read the operation data between the first multi-pipelined MDC unit 500 and the second multi-pipelined MDC unit 700. By changing the delayer positions in the second multi-pipelined MDC unit 700, the time sequence of signals is changed to accomplish the butterfly operations.

The above-mentioned first multi-pipelined MDC unit 500 can include M MDCs 510-1 until 510-M, wherein each MDC respectively has two input terminals and two output terminals. In FIG. 3, the input terminals of the MDC 510-1 are denoted with I₁(1)-I₁(2) and the output terminals of the MDC 510-1 are denoted with O₁(1)-O₁(2). Analogically for the rest, the input terminals of the MDC 510-M are denoted with I₁(2M−1)-I₁(2M) and the output terminals of the MDC 510-M are denoted with O₁(2M−1)-O₁(2M). The MDCs 510-1 until 510-M respectively perform a radix-2^{N} first butterfly operation, wherein the outputs of the MDCs 510-1 until 510-M serve as the first operation results.

The above-mentioned second multi-pipelined MDC unit 700 can include M MDCs 710-1 until 710-M, wherein each MDC respectively has two input terminals and two output terminals. In FIG. 3, the input terminals of the MDC 710-1 are denoted with I₂(1)-I₂(2) and the output terminals of the MDC 710-1 are denoted with O₂(1)-O₂(2). Analogically for the rest, the input terminals of the MDC 710-M are denoted with I₂(2M−1)-I₂(2M) and the output terminals of the MDC 710-M are denoted with O₂(2M−1)-O₂(2M). The MDCs 710-1 until 710-M respectively perform a radix-2^{N} second butterfly operation, wherein the outputs of the MDCs 710-1 until 710-M serve as the second operation results.

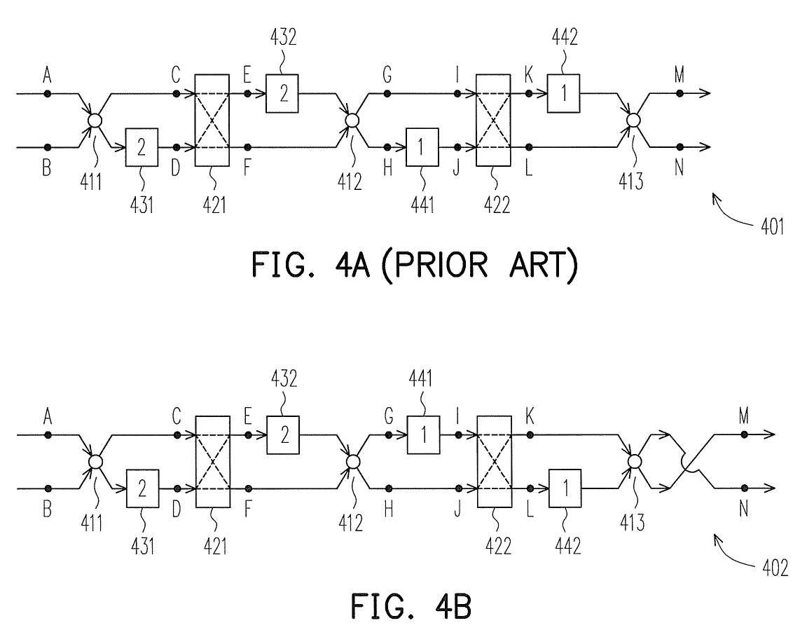

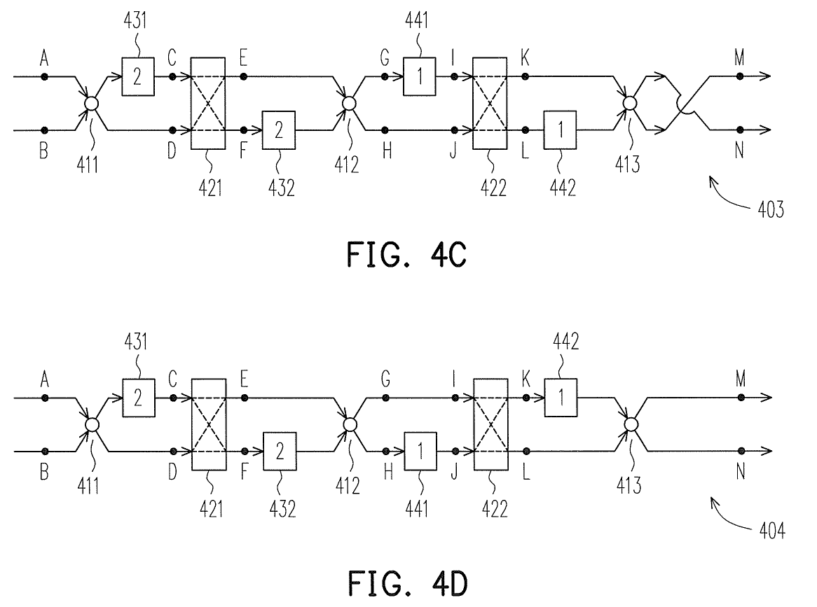

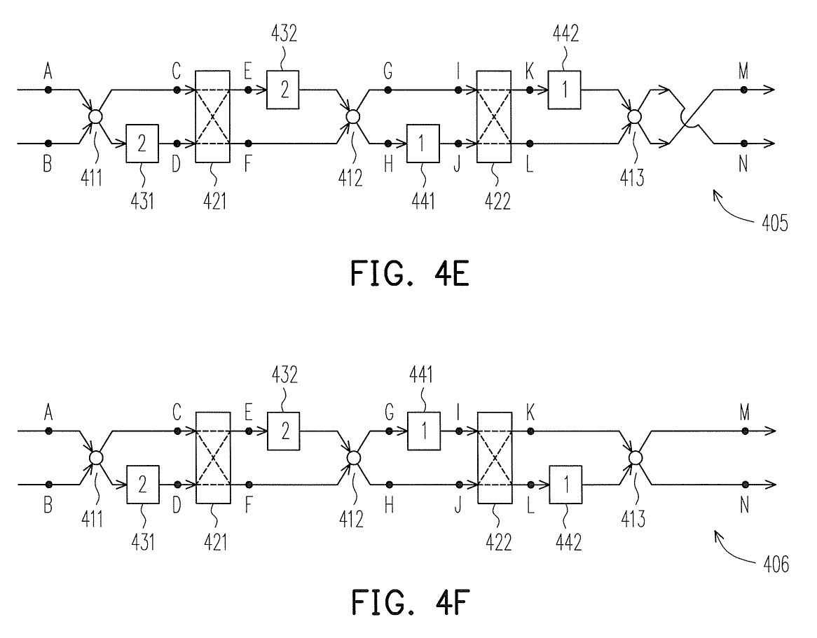

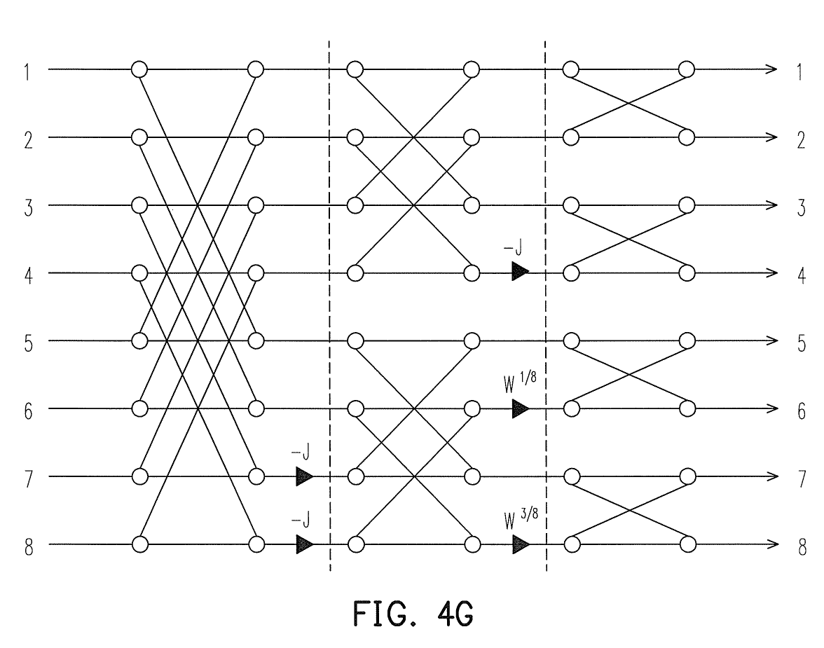

Anyone skilled in the art can determine the above-mentioned N value according to the design requirement. In the following, the depiction is aimed at the situation of, for example, N=3. That is, in the following embodiment, the MDCs 510-1 until 510-M and the MDCs 710-1 until 710-M in FIG. 3 are radix-2³ butterfly operation circuits. FIG. 4A is a block diagram of a conventional MDC. Referring to FIG. 4A, the MDC 401 herein includes butterfly operators 411-413, switches 421-422, delayers 431-432 and delayers 441-442. The butterfly operators 411-413 perform radix-2 butterfly operations according to the data of the first input terminals and the second input terminals and output the operation results from the first output terminals and the second output terminals thereof. The first input terminal and the second input terminal of the first butterfly operator 411 respectively serve as the first input terminal and the second input terminal of the MDC 401 and respectively receive the butterfly operation data of two points. The input terminal of the first delayer 431 is coupled to the second output terminal of the first butterfly operator 411 and the first delayer 431 delays the received data by two time slots, following by outputting the delayed data from the output terminal thereof.

The first switch 421 has a first terminal, a second terminal, a third terminal and a fourth terminal, wherein the first terminal and the second terminal are respectively coupled to the first output terminal of the first butterfly operator 411 and the output terminal of the first delayer 431. The first switch 421 can respectively electrically connect the first terminal and the second terminal thereof to the third terminal and the fourth terminal thereof, or to the fourth terminal and the third terminal thereof. Similarly, the second switch 422 can respectively electrically connect the first terminal and the second terminal thereof to the third terminal and the fourth terminal thereof, or to the fourth terminal and the third terminal thereof.

The input terminal of the second delayer 432 is coupled to the third terminal of the first switch 421 and the second delayer 432 delays the received data by two time slots, following by outputting the delayed data from the output terminal thereof. The first input terminal of the second butterfly operator 412 is coupled to the output terminal of the second delayer 432 and the second input terminal of the second butterfly operator 412 is coupled to the fourth terminal of the first switch 421. The input terminal of the third delayer 441 is coupled to the second output terminal of the second butterfly operator 412 and the third delayer 441 delays the received data by a time slot, following by outputting the delayed data from the output terminal thereof. The first terminal and the second terminal of the second switch 422 are respectively coupled to the first output terminal of the second butterfly operator 412 and the output terminal of the third delayer 441. The input terminal of the fourth delayer 442 is coupled to the third terminal of the second switch 422 and the fourth delayer 442 delays the received data by a time slot, following by outputting the delayed data from the output terminal thereof. The first input terminal of the third butterfly operator 413 is coupled to the output terminal of the fourth delayer 442, and the second input terminal of the third butterfly operator 413 is coupled to the fourth terminal of the second switch 422. The first output terminal and the second output terminal of the third butterfly operator 413 respectively serve as the first output terminal and the second output terminal of the MDC 401.

FIG. 4G is a diagram showing a butterfly operation network for 8-points FFT operations (i.e., radix-8, and FIG. 4G is a diagram of an 8-points butterfly network). The input data and the output data of the eight points in FIG. 4G are respectively denoted with ‘1’, ‘2’, ‘3’, . . . , ‘8’. It should be noted that only the relative positions of the data denoted with 1-8 are shown in FIG. 4G; for example, ‘2’ in FIG. 4G represents the data of the second point in the radix-8 butterfly operation. Besides, the input data and the output data in FIG. 4G denoted with the same number do not mean both of them have the same value of the data.

The operation result of the MDC 401 must follow the algorithm of the butterfly network. Since the inputs and the outputs of the MDC 401 herein are respectively two data, to accomplish the radix-8 butterfly operation as shown by FIG. 4G, the 8-points data must be completely input within four successive time slots. The operation results are also sequentially output, accordingly.

Table 1 lists the timing relationship of the nodes A-N in FIG. 4A and the corresponding operation statuses of the switches 421 and 422.

TABLE 1

| | time | time | time | time | time | time | time |
|---|---|---|---|---|---|---|---|
| | slot 1 | slot 2 | slot 3 | slot 4 | slot 5 | slot 6 | slot 7 |
| node A | 1 | 2 | 3 | 4 | | | |
| node B | 5 | 6 | 7 | 8 | | | |
| node C | 1 | 2 | 3 | 4 | | | |
| node D | | | 5 | 6 | 7 | 8 | |
| switch 421 | = | = | X | X | = | = | X |
| node E | 1 | 2 | 5 | 6 | | | |
| node F | | | 3 | 4 | 7 | 8 | |
| node G | | | 1 | 2 | 5 | 6 | |
| node H | | | 3 | 4 | 7 | 8 | |
| node I | | | 1 | 2 | 5 | 6 | |
| node J | | | | 3 | 4 | 7 | 8 |
| switch 422 | = | X | = | X | = | X | = |
| node K | | | 1 | 3 | 5 | 7 | |
| node L | | | | 2 | 4 | 6 | 8 |
| node M | | | | 1 | 3 | 5 | 7 |
| node N | | | | 2 | 4 | 6 | 8 |

In Table 1, ‘=’ means the first terminal of the switch 411 (or 422) is electrically connected to the third terminal and the second terminal is electrically connected to the fourth terminal; ‘X’ means the first terminal of the switch 411 (or 422) is electrically connected to the fourth terminal and the second terminal is electrically connected to the third terminal. It can be seen from Table 1 that the MDC 401 of FIG. 4A is able to accomplish a radix-8 butterfly operation (as shown by FIG. 4G).

The embodiment is able to obtain various novel MDCs by changing the positions of the delayers in a conventional pipelined MDC 401 so as to change the sequence of outputting the signals. For example, FIGS. 4B-4F are block diagrams showing different novel MDCs according to the embodiment of the present invention.

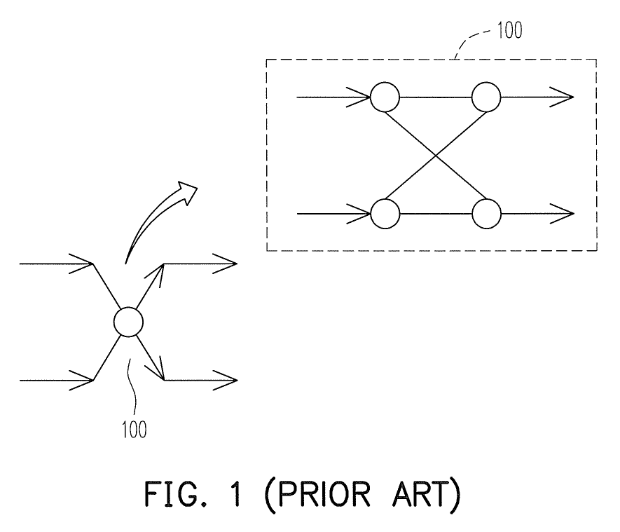

Referring FIG. 4B, the MDC 402 also includes the butterfly operators 411-413, the switches 421-422, the delayers 431-432 and the delayers 441-442. The butterfly operators 411-413 perform radix-2 butterfly operations according to the data of the first input terminals and the second input terminals and output the operation results from the first output terminals and the second output terminals thereof. Anyone skilled in the art can use any architecture to implement the butterfly operators 411-413; for example, by using the radix-2 BU 100 as shown by FIG. 1, the butterfly operators 411-413 of the embodiment can be implemented. The first input terminal and the second input terminal of the first butterfly operator 411 respectively serve as the first input terminal and the second input terminal of the MDC 402. The input terminal of the first delayer 431 is coupled to the second output terminal of the first butterfly operator 411 and the first delayer 431 delays the received data by two time slots, following by outputting the delayed data from the output terminal thereof.

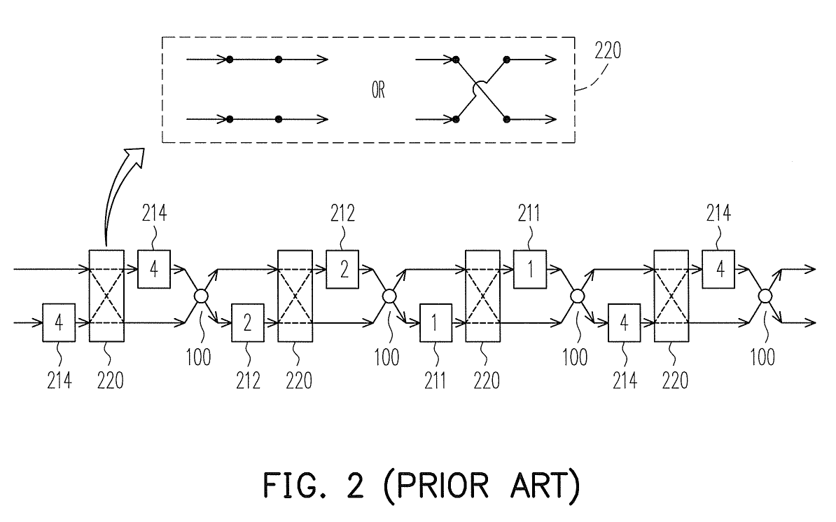

The first terminal and the second terminal of the first switch 421 are respectively coupled to the first output terminal of the first butterfly operator 411 and the output terminal of the first delayer 431. The input terminal of the second delayer 432 is coupled to the third terminal of the first switch 421 and the second delayer 432 delays the received data by two time slots, following by outputting the delayed data from the output terminal thereof. The first input terminal of the second butterfly operator 412 is coupled to the output terminal of the second delayer 432 and the second input terminal of the second butterfly operator 412 is coupled to the fourth terminal of the first switch 421. The input terminal of the third delayer 441 is coupled to the first output terminal of the second butterfly operator 412 and the third delayer 441 delays the received data by a time slot, following by outputting the delayed data from the output terminal thereof. The first terminal and the second terminal of the second switch 422 are respectively coupled to the output terminal of the third delayer 441 and the second output terminal of the second butterfly operator 412. Anyone skilled in the art can use any architecture to implement the switches 421-422; for example, by using the above-mentioned switch 220 as shown by FIG. 2, the switches 421-422 of the embodiment can be implemented.

The input terminal of the fourth delayer 442 is coupled to the fourth terminal of the second switch 422 and the fourth delayer 442 delays the received data by a time slot, following by outputting the delayed data from the output terminal thereof. The first input terminal and the second input terminal of the third butterfly operator 413 are respectively coupled to the third terminal of the second switch 422 and the output terminal of the fourth delayer 442. The first output terminal and the second output terminal of the third butterfly operator 413 respectively serve as the second output terminal and the first output terminal of the MDC 402.

Table 2 lists the timing relationship of the nodes A-N in FIG. 4B and the corresponding operation statuses of the switches 421 and 422.

TABLE 2

| | time | time | time | time | time | time | time |
|---|---|---|---|---|---|---|---|
| | slot 1 | slot 2 | slot 3 | slot 4 | slot 5 | slot 6 | slot 7 |
| node A | 1 | 2 | 3 | 4 | | | |
| node B | 5 | 6 | 7 | 8 | | | |
| node C | 1 | 2 | 3 | 4 | | | |
| node D | | | 5 | 6 | 7 | 8 | |
| switch 421 | = | = | X | X | = | = | X |
| node E | 1 | 2 | 5 | 6 | | | |
| node F | | | 3 | 4 | 7 | 8 | |
| node G | | | 1 | 2 | 5 | 6 | |
| node H | | | 3 | 4 | 7 | 8 | |
| node I | | | | 1 | 2 | 5 | 6 |
| node J | | | 3 | 4 | 7 | 8 | |
| switch 422 | = | X | = | X | = | X | = |
| node K | | | | 4 | 2 | 8 | 6 |
| node L | | | 3 | 1 | 7 | 5 | |
| node M | | | | 3 | 1 | 7 | 5 |
| node N | | | | 4 | 2 | 8 | 6 |

It can be seen from Table 2 that the MDC 402 of FIG. 4B is able to accomplish a radix-8 butterfly operation (as shown by FIG. 4G). The MDC 402 outputs the operation results, wherein the time sequence of operating the signals is different from that of the MDC 401.

Referring FIG. 4C, it illustrates another novel MDC 403. The MDC 403 also includes the butterfly operators 411-413, the switches 421-422, the delayers 431-432 and the delayers 441-442. The first input terminal and the second input terminal of the first butterfly operator 411 respectively serve as the first input terminal and the second input terminal of the MDC 403. The input terminal of the first delayer 431 is coupled to the first output terminal of the first butterfly operator 411 and the first delayer 431 delays the received data by two time slots, following by outputting the delayed data from the output terminal thereof.

The first terminal and the second terminal of the first switch 421 are respectively coupled to the output terminal of the first delayer 431 and the second output terminal of the first butterfly operator 411. The input terminal of the second delayer 432 is coupled to the fourth terminal of the first switch 421 and the second delayer 432 delays the received data by two time slots, following by outputting the delayed data from the output terminal thereof. The first input terminal of the second butterfly operator 412 is coupled to the third terminal of the first switch 421 and the second input terminal of the second butterfly operator 412 is coupled to the output terminal of the second delayer 432. The input terminal of the third delayer 441 is coupled to the first output terminal of the second butterfly operator 412 and the third delayer 441 delays the received data by a time slot, following by outputting the delayed data from the output terminal thereof.

The first terminal and the second terminal of the second switch 422 are respectively coupled to the output terminal of the third delayer 441 and the second output terminal of the second butterfly operator 412. The input terminal of the fourth delayer 442 is coupled to the fourth terminal of the second switch 422 and the fourth delayer 442 delays the received data by a time slot, following by outputting the delayed data from the output terminal thereof. The first input terminal of the third butterfly operator 413 is coupled to the third terminal of the second switch 422 and the second input terminal of the third butterfly operator 413 is coupled to the output terminal of the fourth delayer 442. The first output terminal and the second output terminal of the third butterfly operator 413 respectively serve as the second output terminal and the first output terminal of the MDC 403.

Table 3 lists the timing relationship of the nodes A-N in FIG. 4C and the corresponding operation statuses of the switches 421 and 422.

TABLE 3

| | time | time | time | time | time | time | time |
|---|---|---|---|---|---|---|---|
| | slot 1 | slot 2 | slot 3 | slot 4 | slot 5 | slot 6 | slot 7 |
| node A | 1 | 2 | 3 | 4 | | | |
| node B | 5 | 6 | 7 | 8 | | | |
| node C | | | 1 | 2 | 3 | 4 | |
| node D | 5 | 6 | 7 | 8 | | | |
| switch 421 | = | = | X | X | = | = | X |
| node E | | | 7 | 8 | 3 | 4 | |
| node F | 5 | 6 | 1 | 2 | | | |
| node G | | | 7 | 8 | 3 | 4 | |
| node H | | | 5 | 6 | 1 | 2 | |
| node I | | | | 7 | 8 | 3 | 4 |
| node J | | | 5 | 6 | 1 | 2 | |
| switch 422 | = | X | = | X | = | X | = |
| node K | | | | 6 | 8 | 2 | 4 |
| node L | | | 5 | 7 | 1 | 3 | |
| node M | | | | 5 | 7 | 1 | 3 |
| node N | | | | 6 | 8 | 2 | 4 |

It can be seen from Table 3 that the MDC 403 of FIG. 4C is able to accomplish a radix-8 butterfly operation (as shown by FIG. 4G). The MDC 403 outputs the operation results, wherein the time sequence of operating the signals is different from that of the MDCs 401 and 402.

Referring FIG. 4D, it illustrates yet another novel MDC 404. In the MDC 404, the first input terminal and the second input terminal of the first butterfly operator 411 respectively serve as the first input terminal and the second input terminal of the MDC 404. The input terminal of the first delayer 431 is coupled to the first output terminal of the first butterfly operator 411. The first terminal and the second terminal of the first switch 421 are respectively coupled to the output terminal of the first delayer 431 and the second output terminal of the first butterfly operator 411. The input terminal of the second delayer 432 is coupled to the fourth terminal of the first switch 421.

The first input terminal of the second butterfly operator 412 is coupled to the third terminal of the first switch 421 and the second input terminal of the second butterfly operator 412 is coupled to the output terminal of the second delayer 432. The input terminal of the third delayer 441 is coupled to the second output terminal of the second butterfly operator 412. The first terminal and the second terminal of the second switch 422 are respectively coupled to the first output terminal of the second butterfly operator 412 and the output terminal of the third delayer 441. The input terminal of the fourth delayer 442 is coupled to the third terminal of the second switch 422.

The first input terminal of the third butterfly operator 413 is coupled to the output terminal of the fourth switch 442 and the second input terminal of the third butterfly operator 413 is coupled to the fourth terminal of the second switch 422. The first output terminal and the second output terminal of the third butterfly operator 413 respectively serve as the first output terminal and the second output terminal of the MDC 404.

Table 4 lists the timing relationship of the nodes A-N in FIG. 4D and the corresponding operation statuses of the switches 421 and 422.

TABLE 4

| | time | time | time | time | time | time | time |
|---|---|---|---|---|---|---|---|
| | slot 1 | slot 2 | slot 3 | slot 4 | slot 5 | slot 6 | slot 7 |
| node A | 1 | 2 | 3 | 4 | | | |
| node B | 5 | 6 | 7 | 8 | | | |
| node C | | | 1 | 2 | 3 | 4 | |
| node D | 5 | 6 | 7 | 8 | | | |
| switch 421 | = | = | X | X | = | = | X |
| node E | | | 7 | 8 | 3 | 4 | |
| node F | 5 | 6 | 1 | 2 | | | |
| node G | | | 7 | 8 | 3 | 4 | |
| node H | | | 5 | 6 | 1 | 2 | |
| node I | | | 7 | 8 | 3 | 4 | |
| node J | | | | 5 | 6 | 1 | 2 |
| switch 422 | = | X | = | X | = | X | = |
| node K | | | 7 | 5 | 3 | 1 | |
| node L | | | | 8 | 6 | 4 | 2 |
| node M | | | | 7 | 5 | 3 | 1 |
| node N | | | | 8 | 6 | 4 | 2 |

It can be seen from Table 4 that the MDC 404 of FIG. 4D is able to accomplish a radix-8 butterfly operation (as shown by FIG. 4G). The MDC 404 outputs the operation results, wherein the time sequence of operating the signals is different from that of the MDCs 401, 402 and 403.

Referring FIG. 4E, it illustrates yet another novel MDC 405. In the MDC 405, the first input terminal and the second input terminal of the first butterfly operator 411 respectively serve as the first input terminal and the second input terminal of the MDC 405. The first output terminal and the second output terminal of the third butterfly operator 413 respectively serve as the second output terminal and the first output terminal of the MDC 405.

The input terminal of the first delayer 431 is coupled to the second output terminal of the first butterfly operator 411. The first terminal and the second terminal of the first switch 421 are respectively coupled to the first output terminal of the first butterfly operator 411 and the output terminal of the first delayer 431. The input terminal of the second delayer 432 is coupled to the third terminal of the first switch 421. The first input terminal and the second input terminal of the second butterfly operator 412 are respectively coupled to the output terminal of the second delayer 432 and the fourth terminal of the first switch 421. The input terminal of the third delayer 441 is coupled to second output terminal of the second butterfly operator 412. The first terminal and the second terminal of the second switch 422 are respectively coupled to the first output terminal of the second butterfly operator 412 and the output terminal of the third delayer 441. The input terminal of the fourth delayer 442 is coupled to the third terminal of the second switch 422. The first input terminal and the second input terminal of the third butterfly operator 413 are respectively coupled to the output terminal of the fourth delayer 442 and the fourth terminal of the second switch 422.

Table 5 lists the timing relationship of the nodes A-N in FIG. 4E and the corresponding operation statuses of the switches 421 and 422.

TABLE 5

| | time | time | time | time | time | time | time |
|---|---|---|---|---|---|---|---|
| | slot 1 | slot 2 | slot 3 | slot 4 | slot 5 | slot 6 | slot 7 |
| node A | 1 | 2 | 3 | 4 | | | |
| node B | 5 | 6 | 7 | 8 | | | |
| node C | 1 | 2 | 3 | 4 | | | |
| node D | | | 5 | 6 | 7 | 8 | |
| switch 421 | = | = | X | X | = | = | X |
| node E | 1 | 2 | 5 | 6 | | | |
| node F | | | 3 | 4 | 7 | 8 | |
| node G | | | 1 | 2 | 5 | 6 | |
| node H | | | 3 | 4 | 7 | 8 | |
| node I | | | 1 | 2 | 5 | 6 | |
| node J | | | | 3 | 4 | 7 | 8 |
| switch 422 | = | X | = | X | = | X | = |
| node K | | | 1 | 3 | 5 | 7 | |
| node L | | | | 2 | 4 | 6 | 8 |
| node M | | | | 2 | 4 | 6 | 8 |
| node N | | | | 1 | 3 | 5 | 7 |

It can be seen from Table 2 that the MDC 405 of FIG. 4E is able to accomplish a radix-8 butterfly operation (as shown by FIG. 4G). The MDC 405 outputs the operation results, wherein the time sequence of operating the signals is different from that of the MDCs 401, 402, 403 and 404.

Referring FIG. 4F, it illustrates yet another novel MDC 406. In the MDC 406, the first input terminal and the second input terminal of the first butterfly operator 411 respectively serve as the first input terminal and the second input terminal of the MDC 406. The first output terminal and the second output terminal of the third butterfly operator 413 respectively serve as the first output terminal and the second output terminal of the MDC 406.

The input terminal of the first delayer 431 is coupled to the second output terminal of the first butterfly operator 411. The first terminal and the second terminal of the first switch 421 are respectively coupled to the first output terminal of the first butterfly operator 411 and the output terminal of the first delayer 431. The input terminal of the second delayer 432 is coupled to the third terminal of the first switch 421. The first input terminal and the second input terminal of the second butterfly operator 412 are respectively coupled to the output terminal of the second delayer 432 and the fourth terminal of the first switch 421.

The input terminal of the third delayer 441 is coupled to the first output terminal of the second butterfly operator 412. The first terminal and the second terminal of the second switch 422 are respectively coupled to the output terminal of the third delayer 441 and the second output terminal of the second butterfly operator 412. The input terminal of the fourth delayer 442 is coupled to the fourth terminal of the second switch 422. The first input terminal and the second input terminal of the third butterfly operator 413 are respectively coupled to the third terminal of the second switch 422 and the output terminal of the fourth delayer 442.

Table 6 lists the timing relationship of the nodes A-N in FIG. 4F and the corresponding operation statuses of the switches 421 and 422.

TABLE 6

| | time | time | time | time | time | time | time |
|---|---|---|---|---|---|---|---|
| | slot 1 | slot 2 | slot 3 | slot 4 | slot 5 | slot 6 | slot 7 |
| node A | 1 | 2 | 3 | 4 | | | |
| node B | 5 | 6 | 7 | 8 | | | |
| node C | 1 | 2 | 3 | 4 | | | |
| node D | | | 5 | 6 | 7 | 8 | |
| switch 421 | = | = | X | X | = | = | X |
| node E | 1 | 2 | 5 | 6 | | | |
| node F | | | 3 | 4 | 7 | 8 | |
| node G | | | 1 | 2 | 5 | 6 | |
| node H | | | 3 | 4 | 7 | 8 | |
| node I | | | | 1 | 2 | 5 | 6 |
| node J | | | 3 | 4 | 7 | 8 | |
| switch 422 | = | X | = | X | = | X | = |
| node K | | | | 4 | 2 | 8 | 6 |
| node L | | | 3 | 1 | 7 | 5 | |
| node M | | | | 4 | 2 | 8 | 6 |
| node N | | | | 3 | 1 | 7 | 5 |

It can be seen from Table 6 that the MDC 406 of FIG. 4F is able to accomplish a radix-8 butterfly operation (as shown by FIG. 4G). The MDC 406 outputs the operation results, wherein the time sequence of operating the signals is different from that of the MDCs 401, 402, 403, 404 and 405.

By using the above-mentioned novel MDCs as the first multi-pipelined MDC unit 500 and the second multi-pipelined MDC unit 700, there is no need to use a memory for accessing data between the operation circuits, which is advantageous not only in reducing the memory size, but also in reducing the power consumption of the memory. The N value, as described above, can be determined by the designer; the M value can be determined by anyone skilled in the art according to the design requirement as well. In the following, a case of M=8 and N=3 is exemplarily explained. That is, the first multi-pipelined MDC unit 500 and the second multi-pipelined MDC unit 700 are assumed to perform in parallel way eight radix-2³ butterfly operations to accomplish a 64-points FFT operation.

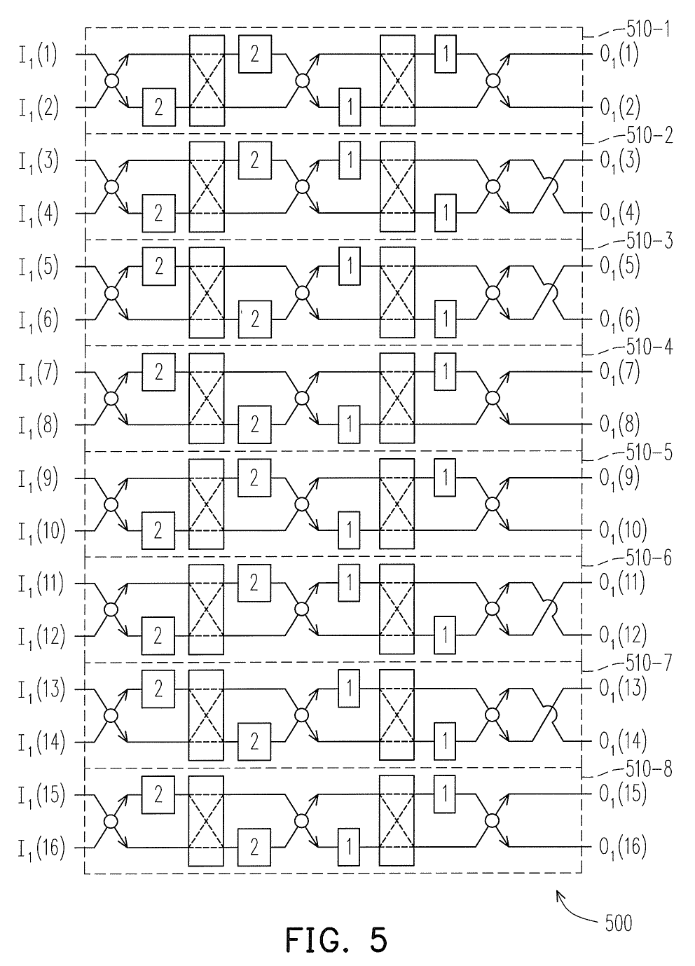

FIG. 5 is a block diagram of the first multi-pipelined MDC unit 500 in FIG. 3 according to the embodiment of the present invention. The first multi-pipelined MDC unit 500 includes eight MDCs 510-1 until 510-M, i.e., the first multi-pipelined MDC unit 500 has 16 input terminals I₁(1)-I₁(16) and 16 output terminals O₁(1)-O₁(16) in total. In this embodiment, the MDCs 510-1 and 510-5 are implemented by the MDC 401 as shown by FIG. 4A; the MDCs 510-2 and 510-6 are implemented by the MDC 402 as shown by FIG. 4B; the MDCs 510-3 and 510-7 are implemented by the MDC 403 as shown by FIG. 4C; the MDCs 510-4 and 510-8 are implemented by the MDC 404 as shown by FIG. 4D. The novel MDCs of the present invention, as explained by the above-mentioned embodiments, would directly rearrange the operation time sequence of the signals in the circuit. By changing the relative positions of the internal delayers, the multi-pipelined MDC units are in series connection to form a 2^{2N}-points processor. When the processor serves as a processing element to perform an FFT of Y-points (Y is greater than 2^{2N}), the memory capacity can be largely saved together with a smaller circuit area. In this way, the power consumption can be significantly reduced.

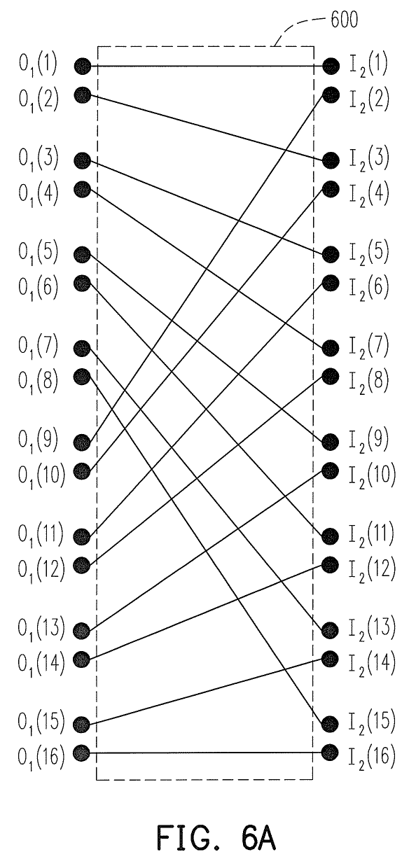

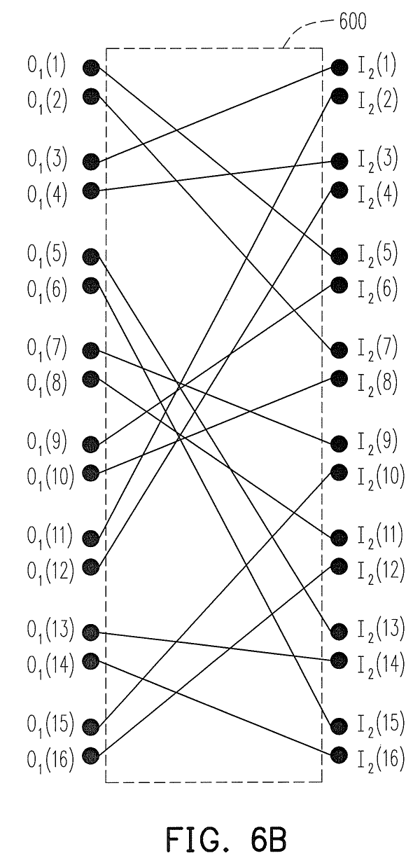

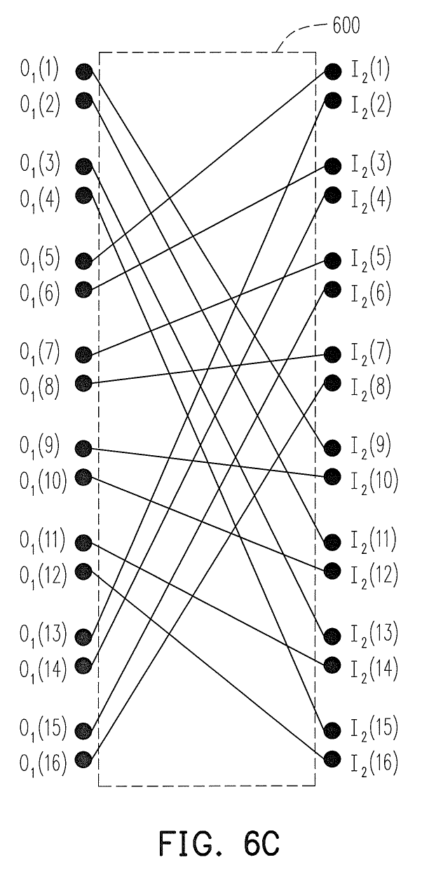

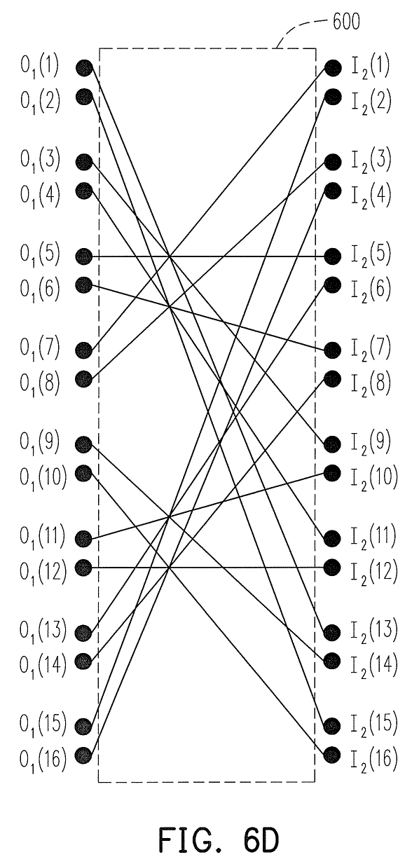

FIGS. 6A-6D are diagrams showing the internal linking statuses of the switching network 600 in FIG. 3 according to the embodiment of the present invention. The first operation results of the first multi-pipelined MDC unit 500 are denoted with O₁(1)-O₁(16) and the input terminals of the second multi-pipelined MDC unit 700 are denoted with I₂(1)-I₂(16). The switching network 600 sends the first operation result O₁(i) to the input terminals I₂(2i−1−15div(i/9)) of the second multi-pipelined MDC unit 700 at a first time slot, wherein i is an integer and 0<i<17. In other words, the switching network 600 respectively sends the first operation results O₁(1)-O₁(16) at a first time slot to the input terminals I₂(1), I₂(3), I₂(5), I₂(7), I₂(9), I₂(11), I₂(13), I₂(15), I₂(2), I₂(4), I₂(6), I₂(8), I₂(10) and I₂(12), I₂(14), I₂(16) of the second multi-pipelined MDC unit 700, as shown by FIG. 6A.

FIG. 6B is a diagram showing the internal linking statuses of the switching network 600 at a second time slot. At the second time slot, the switching network 600 respectively sends the first operation results O₁(1)-O₁(16) to the input terminals I₂(5), I₂(7), I₂(1), I₂(3), I₂(13), I₂(15), I₂(9), I₂(11), I₂(6), I₂(8), I₂(2) and I₂(4), I₂(14), I₂(16), I₂(10) and I₂(12) of the second multi-pipelined MDC unit 700.

At a third time slot, the switching network 600 changes the internal linking statuses thereof once more. As shown by FIG. 6C, the switching network 600 respectively sends the first operation results O₁(1)-O₁(16) at the third time slot to the input terminals I₂(9), I₂(11), I₂(13), I₂(15), I₂(1), I₂(3), I₂(5), I₂(7), I₂(10), I₂(12), I₂(16), I₂(2), I₂(4), I₂(6) and I₂(8) of the second multi-pipelined MDC unit 700.

FIG. 6D is a diagram showing the internal linking statuses of the switching network 600 at a fourth time slot. The switching network 600 respectively sends the first operation results O₁(1)-O₁(16) at a fourth time slot to the input terminals I₂(13), I₂(15), I₂(9), I₂(11), I₂(5), I₂(7), I₂(1), I₂(3), I₂(14), I₂(16), I₂(10), I₂(12), I₂(6), I₂(8), I₂(2) and I₂(4) of the second multi-pipelined MDC unit 700.

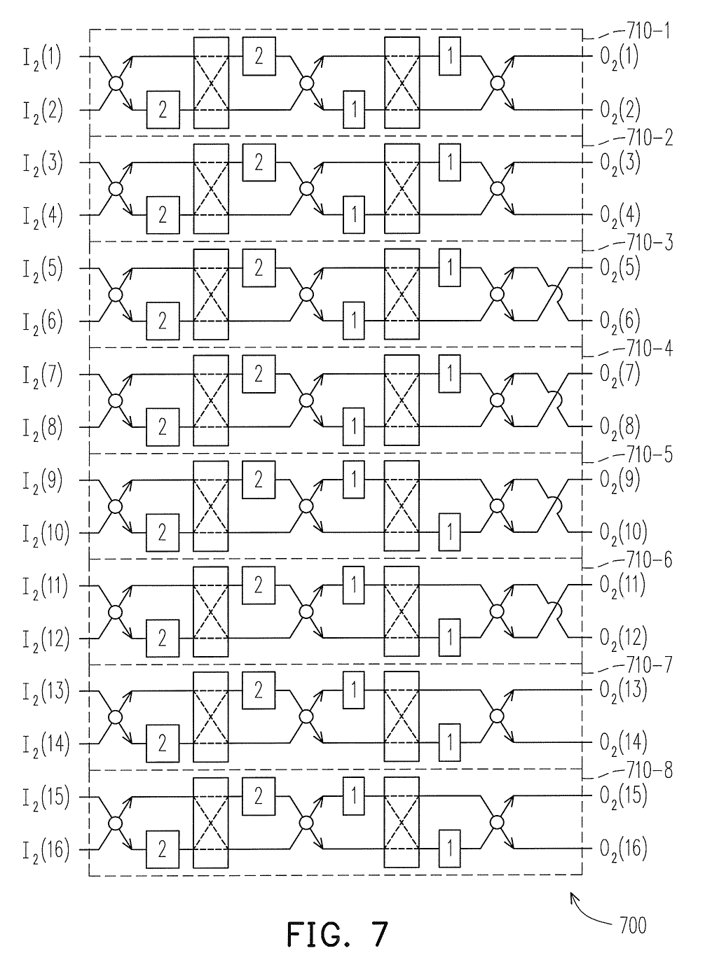

FIG. 7 is a block diagram of the second multi-pipelined MDC unit 700 in FIG. 3 according to the embodiment of the present invention. The second multi-pipelined MDC unit 700 includes eight MDCs 710-1 until 710-M, i.e., the second multi-pipelined MDC unit 700 has 16 input terminals I₂(1)-I₂(16) and 16 output terminals O₂(1)-O₂(16) in total. In this embodiment, the MDCs 710-1 and 710-2 are implemented by the MDC 401 as shown by FIG. 4A; the MDCs 710-3 and 710-4 are implemented by the MDC 405 as shown by FIG. 4E; the MDCs 710-5 and 710-6 are implemented by the MDC 402 as shown by FIG. 4B; the MDCs 710-7 and 710-8 are implemented by the MDC 406 as shown by FIG. 4F.

Since 4096 is the second power of 64, so that 64-points operation units can build a 4096-points FFT processor. In the embodiment, the 64-points operation unit (for example, M=8, as shown by FIG. 3) can be built by using the butterfly unit of FIGS. 5 and 7 and the switching network of FIG. 6. In an operation unit, the structure is mainly comprises two butterfly units 500 and 700 in series connection. Since in each of the two butterfly units, novel MDCs are employed, so that only a simple internal switch or a switching network is needed to link the butterfly units 500 and 700 without a memory for accessing data.

Table 7 lists the data timing relationship of the first multi-pipelined MDC unit 500 in a 64-points operation unit of the embodiment.

TABLE 7

| | time slot | | | | | | | | | |
|---|---|---|---|---|---|---|---|---|---|---|
| | 1 | 2 | 3 | 4 | 5 | 6 | 7 | 8 | 9 | 10 |
| I₁(1) | 1 | 9 | 17 | 25 | | | | | | |
| I₁(2) | 33 | 41 | 49 | 57 | | | | | | |
| I₁(3) | 2 | 10 | 18 | 26 | | | | | | |
| I₁(4) | 34 | 42 | 50 | 58 | | | | | | |
| I₁(5) | 3 | 11 | 19 | 27 | | | | | | |
| I₁(6) | 35 | 43 | 51 | 59 | | | | | | |
| I₁(7) | 4 | 12 | 20 | 28 | | | | | | |
| I₁(8) | 36 | 44 | 52 | 60 | | | | | | |
| I₁(9) | 5 | 13 | 21 | 29 | | | | | | |
| I₁(10) | 37 | 45 | 53 | 61 | | | | | | |
| I₁(11) | 6 | 14 | 22 | 30 | | | | | | |
| I₁(12) | 38 | 46 | 54 | 62 | | | | | | |
| I₁(13) | 7 | 15 | 23 | 31 | | | | | | |
| I₁(14) | 39 | 47 | 55 | 63 | | | | | | |
| I₁(15) | 8 | 16 | 24 | 32 | | | | | | |
| I₁(16) | 40 | 48 | 56 | 64 | | | | | | |
| O₁(1) | | | | 1 | 17 | 33 | 49 | | | |
| O₁(2) | | | | 9 | 25 | 41 | 57 | | | |
| O₁(3) | | | | 18 | 2 | 50 | 34 | | | |
| O₁(4) | | | | 26 | 10 | 58 | 42 | | | |
| O₁(5) | | | | 35 | 51 | 3 | 19 | | | |
| O₁(6) | | | | 43 | 59 | 11 | 27 | | | |
| O₁(7) | | | | 52 | 36 | 20 | 4 | | | |
| O₁(8) | | | | 60 | 44 | 28 | 12 | | | |
| O₁(9) | | | | 5 | 21 | 37 | 53 | | | |
| O₁(10) | | | | 13 | 29 | 45 | 61 | | | |
| O₁(11) | | | | 22 | 6 | 54 | 38 | | | |
| O₁(12) | | | | 30 | 14 | 62 | 46 | | | |
| O₁(13) | | | | 39 | 55 | 7 | 23 | | | |
| O₁(14) | | | | 47 | 63 | 15 | 31 | | | |
| O₁(15) | | | | 56 | 40 | 24 | 8 | | | |
| O₁(16) | | | | 64 | 48 | 32 | 16 | | | |
| I₂(1) | | | | 1 | 2 | 3 | 4 | | | |
| I₂(2) | | | | 5 | 6 | 7 | 8 | | | |
| I₂(3) | | | | 9 | 10 | 11 | 12 | | | |
| I₂(4) | | | | 13 | 14 | 15 | 16 | | | |
| I₂(5) | | | | 18 | 17 | 20 | 19 | | | |
| I₂(6) | | | | 22 | 21 | 24 | 23 | | | |
| I₂(7) | | | | 26 | 25 | 28 | 27 | | | |
| I₂(8) | | | | 30 | 29 | 32 | 31 | | | |
| I₂(9) | | | | 35 | 36 | 33 | 34 | | | |
| I₂(10) | | | | 39 | 40 | 37 | 38 | | | |
| I₂(11) | | | | 43 | 44 | 41 | 42 | | | |
| I₂(12) | | | | 47 | 48 | 45 | 46 | | | |
| I₂(13) | | | | 52 | 51 | 50 | 49 | | | |
| I₂(14) | | | | 56 | 55 | 54 | 53 | | | |
| I₂(15) | | | | 60 | 59 | 58 | 57 | | | |
| I₂(16) | | | | 64 | 63 | 62 | 61 | | | |
| O₂(1) | | | | | | | 1 | 3 | 5 | 7 |
| O₂(2) | | | | | | | 2 | 4 | 6 | 8 |
| O₂(3) | | | | | | | 9 | 11 | 13 | 15 |
| O₂(4) | | | | | | | 10 | 12 | 14 | 16 |
| O₂(5) | | | | | | | 17 | 19 | 21 | 23 |
| O₂(6) | | | | | | | 18 | 20 | 22 | 24 |
| O₂(7) | | | | | | | 25 | 27 | 29 | 31 |
| O₂(8) | | | | | | | 26 | 28 | 30 | 32 |
| O₂(9) | | | | | | | 33 | 35 | 37 | 39 |
| O₂(10) | | | | | | | 34 | 36 | 38 | 40 |
| O₂(11) | | | | | | | 41 | 43 | 45 | 47 |
| O₂(12) | | | | | | | 42 | 44 | 46 | 48 |
| O₂(13) | | | | | | | 49 | 51 | 53 | 55 |
| O₂(14) | | | | | | | 50 | 52 | 54 | 56 |
| O₂(15) | | | | | | | 57 | 59 | 61 | 63 |
| O₂(16) | | | | | | | 58 | 60 | 62 | 64 |

In Table 7, except ‘time slot’ row, the other figures, such as ‘1’, ‘2’, ‘3’, . . . , ‘64’ represent the relative position of the data in a 64-points FFT operation (64-points butterfly network). For example, ‘13’ in Table 7 represents the data of the thirteenth point in the 64-points FFT operation. Besides, any two same numbers at different time slots in Table 7 do not mean they have the same values of data.

Referring to FIGS. 3, 5, 6 and 7 and Table 7, since the first multi-pipelined MDC unit 500 has 16 input terminals I₁(1)-I₁(16) only, in order to accomplish a 64-points operation, the data must be successively input within four consecutive time slots (the time slots 1-4 in Table 7). The data of 16 points are inputs to the input terminals of the first multi-pipelined MDC unit 500 every time. After the operations of the first multi-pipelined MDC unit 500, the first operation results are sequentially output from the 16 output terminals O₁(1)-O₁(16), respectively in four times (the time slots 4-7 in Table 7). The switching network 600 respectively switches the data of the output terminals O₁(1)-O₁(16) to the input terminals I₂(1)-I₂(16) of the second multi-pipelined MDC unit 700 at the first time slot, the second time slot, the third time slot and the fourth time slot according to the linking statuses shown by FIGS. 6A-6D. After the operations of the second multi-pipelined MDC unit 700, the second operation results are sequentially output from the 16 output terminals O₂(1)-O₂(16), respectively in four times (the time slots 7-10 in Table 7).

It should be noted that the above-mentioned 64-points FFT operation circuit comprising the MDC circuits and the switching network is not an exclusive solution. Taking a radix-2³ MDC as an example, there are eight modified architectures in total depending on the different positions of the delayers and the different positions of the output terminals, while the above-mentioned embodiments provide six architectures only, which means there is room for a designer to select MDCs and the corresponding switching networks to build different processing element circuits from the given ones according to the preference and different signal sequences. Similarly, there are other circuit architectures of a processing element in response to different N and different number of points, which is omitted to describe for simplicity.

In comparison with the conventional MDC processors, the invented processor can reduce the number of accessing the memory, effectively reduce the power consumption and largely reduce the required memory size, for example, a Y-points operation requires a memory size of Y only. In addition, the signals between the first multi-pipelined MDC unit 500 and the second multi-pipelined MDC unit 700 are communicated by means of the methodology of ‘inherent cache’ instead of using a memory for accessing data.

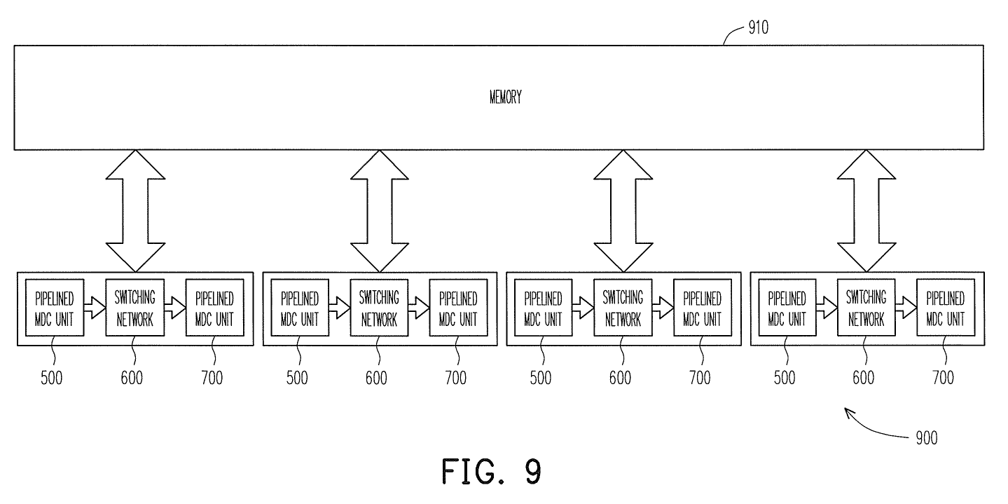

In order to increase the throughput of the invented FFT processor, only some processing elements need to be added, for example, as shown by FIG. 9. FIG. 9 is a block diagram showing another FFT processor 900 according to the embodiment of the present invention. In the FFT processor 900, a plurality of sets of the circuits (processing elements) as shown by FIG. 3 are employed. Each of the processing elements is coupled to a memory 910, which provides the data required by the multi-pipelined MDC unit 500 in each processing element to perform in parallel way M radix-2^{N} butterfly operations. Besides, the multi-pipelined MDC unit 700 in each processing element is allowed to write the operation results into the memory 910.

A 4096-pointe FFT processor can be fabricated by using the 90 nm CMOS (complementary metal-oxide semiconductor) process to combine two processing elements into a processor. In this way, the throughput of the circuit at the operation frequency of 500 MHz can reach 8 Giga-samples per second; in association with different modulations, the maximum data transmission rate reaches 28 Giga-bits per second. When the operation voltage is 1 V, the power consumption is nearly 1 W. Table 8 lists the relevant simulation parameters of the circuit.

TABLE 8
The Simulated Parameters of an FFT Processor Circuit
fabricated with 90 nm CMOS Process

| Items | Specification |
|---|---|
| FFT size | 4096-points |
| Technology | UMC 90 nm 1P9M |
| | CMOS process |
| Supply voltage | 2.5 V/1.0 V |
| Working frequency | 500 MHz |
| Throughput rate | 8 Giga-sample/s |
| Memory size | 22 × 8192 bit |
| Gate count | 727K |
| (excl. memory) | |
| Core size | 1760 × 2650 μm2 |
| Power consumption | 1055 mW@1.0 V |
| Max. Raw Data Rate | 28.44 Gbps |

In comparison with the prior art, the invented FFT processors are advantageous not only in high throughput and high usage efficiency (100%), but also in largely reducing the required memory size. For an invented FFT processor capable of accomplishing Y-points operation, only a memory size of Y is needed as described above, which reduces the circuit area, lowers the number of accessing the memory and further effectively reduces the power consumption.

In summary, the above-mentioned embodiments use multi-pipelined MDC units and a switching network to implement an FFT processor, wherein the core of each processing element is various novel MDCs. In the above-mentioned embodiments, one of the various MDC architectures in association with an rearrangement of the operation time sequence of the signals in parallel processing builds a multi-pipelined processing element, which is advantageous not only in high usage efficiency and smaller area of an processing element, but also in lowering the number of accessing the memory between the processing elements, reducing the required memory size, reducing the power consumption and largely reducing the circuit area required by the memory. Since the FFT processor provided by the above-mentioned embodiments can be fabricated by using a low-cost CMOS process, the present invention has more advantages: further reducing the power consumption, solving the problems of heat dissipation and battery lifetime and compacting the circuit area. In short, the provided technique benefits for developing a handheld electronic product.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A Fast Fourier Transform (FFT) processor, comprising:
a first multi-pipelined multipath delay commutator (MDC) unit, for performing M radix-2^{N} first butterfly operations in parallel way so as to output a plurality of first operation results, wherein M and N are integers greater than 1;
a switching network, coupled to the first multi-pipelined MDC unit for changing the relative positions of the first operation results; and
a second multi-pipelined MDC unit, coupled to the switching network for using the first operation results after changing the relative positions thereof to perform M radix-2^{N} second butterfly operations in parallel way so as to output a plurality of second operation results.

2. The FFT processor as claimed in claim 1, wherein the first multi-pipelined MDC unit comprises:
M multipath delay commutators, for respectively performing a radix-2^{N} first butterfly operation, wherein the outputs of the multipath delay commutators serve as the first operation results.

3. The FFT processor as claimed in claim 2, wherein one of the multipath delay commutators comprises:
a first butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal and the second input terminal of the first butterfly operator respectively serve as the first input terminal and the second input terminal of the multipath delay commutator;
a first delayer, having an input terminal and an output terminal, wherein the input terminal is coupled to the second output terminal of the first butterfly operator to delay the received data by two time slots, following by outputting the delayed data from the output terminal thereof;
a first switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the first switch are respectively coupled to the first output terminal of the first butterfly operator and the output terminal of the first delayer;
a second delayer, having an input terminal and an output terminal, wherein the input terminal is coupled to the third terminal of the first switch to delay the received data by two time slots, following by outputting the delayed data from the output terminal thereof;
a second butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the second butterfly operator is coupled to the output terminal of the second delayer and the second input terminal of the second butterfly operator is coupled to the fourth terminal of the first switch;
a third delayer, having an input terminal and an output terminal, wherein the input terminal is coupled to the second output terminal of the second butterfly operator to delay the received data by a time slot, following by outputting the delayed data from the output terminal thereof;
a second switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the second switch are respectively coupled to the first output terminal of the second butterfly operator and the output terminal of the third delayer;
a fourth delayer, having an input terminal and an output terminal, wherein the input terminal is coupled to the third terminal of the second switch to delay the received data by a time slot, following by outputting the delayed data from the output terminal thereof; and
a third butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the third butterfly operator is coupled to the output terminal of the fourth delayer, the second input terminal of the third butterfly operator is coupled to the fourth terminal of the second switch and the first output terminal and the second output terminal of the third butterfly operator respectively serve as the first output terminal and the second output terminal of the multipath delay commutator.

4. The FFT processor as claimed in claim 2, wherein one of the multipath delay commutators comprises:
a first butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal and the second input terminal of the first butterfly operator respectively serve as the first input terminal and the second input terminal of the multipath delay commutator;
a first delayer, having an input terminal and an output terminal, wherein the input terminal is coupled to the second output terminal of the first butterfly operator to delay the received data by two time slots, following by outputting the delayed data from the output terminal thereof;
a first switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the first switch are respectively coupled to the first output terminal of the first butterfly operator and the output terminal of the first delayer;
a second delayer, having an input terminal and an output terminal, wherein the input terminal is coupled to the third terminal of the first switch to delay the received data by two time slots, following by outputting the delayed data from the output terminal thereof;
a second butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the second butterfly operator is coupled to the output terminal of the second delayer and the second input terminal of the second butterfly operator is coupled to the fourth terminal of the first switch;
a third delayer, having an input terminal and an output terminal, wherein the input terminal is coupled to the first output terminal of the second butterfly operator to delay the received data by a time slot, following by outputting the delayed data from the output terminal thereof;
a second switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the second switch are respectively coupled to the output terminal of the third delayer and the second output terminal of the second butterfly operator;
a fourth delayer, having an input terminal and an output terminal, wherein the input terminal is coupled to the fourth terminal of the second switch to delay the received data by a time slot, following by outputting the delayed data from the output terminal thereof; and
a third butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the third butterfly operator is coupled to the third terminal of the second switch, the second input terminal of the third butterfly operator is coupled to the output terminal of the fourth delayer and the first output terminal and the second output terminal of the third butterfly operator respectively serve as the second output terminal and the first output terminal of the multipath delay commutator.

5. The FFT processor as claimed in claim 2, wherein one of the multipath delay commutators comprises:
a first butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal and the second input terminal of the first butterfly operator respectively serve as the first input terminal and the second input terminal of the multipath delay commutator;
a first delayer, having an input terminal and an output terminal, wherein the input terminal is coupled to the first output terminal of the first butterfly operator to delay the received data by two time slots, following by outputting the delayed data from the output terminal thereof;
a first switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the first switch are respectively coupled to the output terminal of the first delayer and the second output terminal of the first butterfly operator;
a second delayer, having an input terminal and an output terminal, wherein the input terminal is coupled to the fourth terminal of the first switch to delay the received data by two time slots, following by outputting the delayed data from the output terminal thereof;
a second butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the second butterfly operator is coupled to the third terminal of the first switch and the second input terminal of the second butterfly operator is coupled to the output terminal of the second delayer;
a third delayer, having an input terminal and an output terminal, wherein the input terminal is coupled to the first output terminal of the second butterfly operator to delay the received data by a time slot, following by outputting the delayed data from the output terminal thereof;
a second switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the second switch are respectively coupled to the output terminal of the third delayer and the second output terminal of the second butterfly operator;
a fourth delayer, having an input terminal and an output terminal, wherein the input terminal is coupled to the fourth terminal of the second switch to delay the received data by a time slot, following by outputting the delayed data from the output terminal thereof; and
a third butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the third butterfly operator is coupled to the third terminal of the second switch, the second input terminal of the third butterfly operator is coupled to the output terminal of the fourth delayer and the first output terminal and the second output terminal of the third butterfly operator respectively serve as the second output terminal and the first output terminal of the multipath delay commutator.

6. The FFT processor as claimed in claim 2, wherein one of the multipath delay commutators comprises:
a first butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal and the second input terminal of the first butterfly operator respectively serve as the first input terminal and the second input terminal of the multipath delay commutator;
a first delayer, having an input terminal and an output terminal, wherein the input terminal is coupled to the first output terminal of the first butterfly operator to delay the received data by two time slots, following by outputting the delayed data from the output terminal thereof;
a first switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the first switch are respectively coupled to the output terminal of the first delayer and the second output terminal of the first butterfly operator;
a second delayer, having an input terminal and an output terminal, wherein the input terminal is coupled to the fourth terminal of the first switch to delay the received data by two time slots, following by outputting the delayed data from the output terminal thereof;
a second butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the second butterfly operator is coupled to the third terminal of the first switch and the second input terminal of the second butterfly operator is coupled to the output terminal of the second delayer;
a third delayer, having an input terminal and an output terminal, wherein the input terminal is coupled to the second output terminal of the second butterfly operator to delay the received data by a time slot, following by outputting the delayed data from the output terminal thereof;
a second switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the second switch are respectively coupled to the first output terminal of the second butterfly operator and the output terminal of the third delayer;
a fourth delayer, having an input terminal and an output terminal, wherein the input terminal is coupled to the third terminal of the second switch to delay the received data by a time slot, following by outputting the delayed data from the output terminal thereof; and
a third butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the third butterfly operator is coupled to the output terminal of the fourth delayer, the second input terminal of the third butterfly operator is coupled to the fourth terminal of the second switch and the first output terminal and the second output terminal of the third butterfly operator respectively serve as the first output terminal and the second output terminal of the multipath delay commutator.

7. The FFT processor as claimed in claim 1, wherein the second multi-pipelined MDC unit comprises:
M multipath delay commutators, for respectively performing a radix-2^{N} first butterfly operation, wherein the outputs of the multipath delay commutators serve as the second operation results.

8. The FFT processor as claimed in claim 7, wherein one of the multipath delay commutators comprises:
a first butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal and the second input terminal of the first butterfly operator respectively serve as the first input terminal and the second input terminal of the multipath delay commutator;
a first delayer, having an input terminal and an output terminal, wherein the input terminal is coupled to the second output terminal of the first butterfly operator to delay the received data by two time slots, following by outputting the delayed data from the output terminal thereof;
a first switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the first switch are respectively coupled to the first output terminal of the first butterfly operator and the output terminal of the first delayer;
a second delayer, having an input terminal and an output terminal, wherein the input terminal is coupled to the third terminal of the first switch to delay the received data by two time slots, following by outputting the delayed data from the output terminal thereof;
a second butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the second butterfly operator is coupled to the output terminal of the second delayer and the second input terminal of the second butterfly operator is coupled to the fourth terminal of the first switch;
a third delayer, having an input terminal and an output terminal, wherein the input terminal is coupled to the second output terminal of the second butterfly operator to delay the received data by a time slot, following by outputting the delayed data from the output terminal thereof;
a second switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the second switch are respectively coupled to the first output terminal of the second butterfly operator and the output terminal of the third delayer;
a fourth delayer, having an input terminal and an output terminal, wherein the input terminal is coupled to the third terminal of the second switch to delay the received data by a time slot, following by outputting the delayed data from the output terminal thereof; and
a third butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the third butterfly operator is coupled to the output terminal of the fourth delayer, the second input terminal of the third butterfly operator is coupled to the fourth terminal of the second switch and the first output terminal and the second output terminal of the third butterfly operator respectively serve as the second output terminal and the first output terminal of the multipath delay commutator.

9. The FFT processor as claimed in claim 7, wherein one of the multipath delay commutators comprises:
a first butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal and the second input terminal of the first butterfly operator respectively serve as the first input terminal and the second input terminal of the multipath delay commutator;
a first delayer, having an input terminal and an output terminal, wherein the input terminal is coupled to the second output terminal of the first butterfly operator to delay the received data by two time slots, following by outputting the delayed data from the output terminal thereof;
a first switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the first switch are respectively coupled to the first output terminal of the first butterfly operator and the output terminal of the first delayer;
a second delayer, having an input terminal and an output terminal, wherein the input terminal is coupled to the third terminal of the first switch to delay the received data by two time slots, following by outputting the delayed data from the output terminal thereof;
a second butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the second butterfly operator is coupled to the output terminal of the second delayer and the second input terminal of the second butterfly operator is coupled to the fourth terminal of the first switch;
a third delayer, having an input terminal and an output terminal, wherein the input terminal is coupled to the first output terminal of the second butterfly operator to delay the received data by a time slot, following by outputting the delayed data from the output terminal thereof;
a second switch, having a first terminal, a second terminal, a third terminal and a fourth terminal for respectively electrically connecting the first terminal and the second terminal thereof to the third terminal and the fourth terminal thereof or to the fourth terminal and the third terminal thereof, wherein the first terminal and the second terminal of the second switch are respectively coupled to the output terminal of the third delayer and the second output terminal of the second butterfly operator;
a fourth delayer, having an input terminal and an output terminal, wherein the input terminal is coupled to the fourth terminal of the second switch to delay the received data by a time slot, following by outputting the delayed data from the output terminal thereof; and
a third butterfly operator, having a first input terminal, a second input terminal, a first output terminal and a second output terminal for performing a radix-2 butterfly operation according to the data of the first input terminal and the second input terminal thereof and outputting the operation results from the first output terminal and the second output terminal thereof, wherein the first input terminal of the third butterfly operator is coupled to the third terminal of the second switch, the second input terminal of the third butterfly operator is coupled to the output terminal of the fourth delayer and the first output terminal and the second output terminal of the third butterfly operator respectively serve as the first output terminal and the second output terminal of the multipath delay commutator.

10. The FFT processor as claimed in claim 1, wherein the first operation results are O₁(1)-O₁(16), the input terminals of the second multi-pipelined MDC unit are I₂(1)-I₂(2), then, the switching network sends the first operation results O₁(i) at a first time slot to the input terminals I₂(2i−1−15div(i/9)) of the second multi-pipelined MDC unit, wherein I is an integer and 0<i<17.

11. The FFT processor as claimed in claim 10, wherein the switching network respectively sends the first operation results O₁(1)-O₁(16) at a second time slot to the input terminals I₂(5), I₂(7), I₂(1), I₂(3), I₂(13), I₂(15), I₂(9), I₂(11), I₂(6), I₂(8), I₂(2), I₂(4), I₂(14), I₂(16), I₂(10) and I₂(12) of the second multi-pipelined MDC unit.

12. The FFT processor as claimed in claim 11, wherein the switching network respectively sends the first operation results I₁(1)-O₁(16) at a third time slot to the input terminals I₂(9), I₂(11), I₂(13), I₂(15), I₂(1), I₂(3), I₂(5), I₂(7), I₂(10), I₂(12), I₂(14), I₂(16), I₂(2), I₂(4), I₂(6) and I₂(8) of the second multi-pipelined MDC unit.

13. The FFT processor as claimed in claim 12, wherein the switching network respectively sends the first operation results O₁(1)-O₁(16) at a fourth time slot to the input terminals I₂(13), I₂(15), I₂(9), I₂(11), I₂(5), I₂(7), I₂(1), I₂(3), I₂(14), I₂(16), I₂(10), I₂(12), I₂(6), I₂(8), I₂(2) and I₂(4) of the second multi-pipelined MDC unit.

14. The FFT processor as claimed in claim 1, further comprising a memory for providing the first multi-pipelined MDC unit with the required data and providing a memory space for the second multi-pipelined MDC unit to write the operation results into the memory space.
